(19) United States
(12) Patent Application Publication
(10) Pub. No.: US 2019/0134907 A1
(43) Pub. Date: May 9, 2019

(54) 3D Printer Having a Coating Device and a Coating Device Cleaning Device

(71) Applicant: ExOne GmbH, Gersthofen (DE)

(72) Inventors: Rainer Hoechsmann, Langenneufnach (DE); Helmut Ortmeier, Garching (DE); Alexander Mueller, Diedorf-Vogelsang (DE); Peter Soehnel, Buchloe (DE)

(21) Appl. No.: 16/094,321

(22) PCT Filed: Mar. 10, 2017
(86) PCT No.: PCT/EP2017/055752

§ 371 Date: Oct. 17, 2018

(30) Foreign Application Priority Data
May 12, 2016 (DE) 10 2016 108 833.1

(51) Int. Cl. B29C 64/35; B29C 64/165

(52) U.S. Cl. CPC B29C 64/35; B08B 1/006; B29C 64/165

(57) ABSTRACT

The invention relates to a 3D printer (10) having a coater (30) and a coater-cleaning device (50). The coater (30) has a container (32), which defines an inner hollow space (34) for receiving particulate building material, and a discharge region (36) for discharging the particulate building material, said coater being movable into a cleaning position in which the coater is arranged above the coater-cleaning device (50). The coater-cleaning device (50) has a wiper element (52) for wiping the discharge region (36), said wiper element being formed from an absorbent material which is configured to receive a liquid cleaning agent inside the material.

The present invention relates to a 3D printer having a coating device and a coating device cleaning device and to a method for cleaning a coating device of a 3D printer. For example, the present invention relates to a 3D printer having a coating device and a coating device cleaning device according to the preamble of claim 1. A 3D printer of this type is, for example, known from DE 10 2009 056 687 A1.

Various generative manufacturing processes (and consequently various types of 3D printers, i.e. machines/installations for building up a component in layers) are known.

Some generative manufacturing processes have the following steps in common:

(1) First, particulate material is applied over the entire surface of a construction field, so as to form a layer of unsolidified particulate material.

(2) The applied layer of unsolidified particulate material is selectively solidified in a predetermined partial area, for example by selectively printing a treatment agent, for example a binder (alternatively, for example, by laser sintering).

(3) Steps (1) and (2) are repeated to manufacture a desired component. For this purpose, a construction platform on which the component is built up in layers may, for example, be lowered by respectively one layer thickness before a new layer is applied over the entire surface (alternatively, the coating device and the printing device may, for example, be raised by respectively one layer thickness).

(4) Finally, the manufactured component which is supported and surrounded by loose, unsolidified particulate material may be unpacked.

The construction space in which the component or the components is/are manufactured may, for example, be defined by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An upper area of the construction space may, for example, be referred to as construction field. An example of such a construction box is, for example, described in DE 10 2009 056 696 A1.

A coating device (also referred to as a “recoater”) is normally used in the above step (1). Various coating devices are known for use in 3D printers, by means of which a particulate construction material may be applied to the construction field (also referred to as construction surface or construction area) in the form of a uniform layer over the entire surface.

One type of coating device uses a roller (short: “roller coating device”) in front of which first an amount of particulate construction material is put down and which is then horizontally moved across the construction field to apply the particulate construction material in the form of a uniform layer onto the construction field. In this respect, the roller may be rotated opposite to the moving direction. Coating device arrangements with great lengths (and consequently 3D printers with large dimensions) are difficult to realize using a roller coating device, amongst others due to a possible deflection of the roller.

Another kind of coating device (a so-called “container coating device”, for example a “slot coating device”) uses a container which defines an inner cavity for receiving particulate construction material, and has an output region (for example an elongated output region), for example comprising an (elongate) output slot, for outputting the particulate construction material. The container coating device may, for example, be displaceable across a construction field (for example horizontally, for example transverse to the longitudinal direction), so that the particulate construction material can be output onto the construction field through the (elongate) output region to thereby apply a uniform construction material layer over the entire surface of the construction field. The coating device may be elongate, for example to span or to cover the length or width of a rectangular construction field. Coating devices with great lengths (and consequently 3D printers with large dimensions) can be realized quite well using a container coating device.

In the above step (2), a printing device having a print head may for example be used, which applies a treatment agent in a controlled way onto a subarea of the construction material layer applied before. The treatment agent contributes to a (direct and/or later) solidification of the construction material layer in the subarea. For example, the treatment agent may be/contain a binder, for example a binder component of a multicomponent binder.

Alternatively, a laser may, for example, be used in the above step (2) to solidify a subarea of the construction material layer applied previously, for example by sintering or melting the construction material in the subarea.

The present invention relates to a 3D printer having a coating device of the above-described, latter type, short: a “container coating device”, for example a “slot device”.

A coating device of this type may, for example, be provided with a stroking/sweeping member by which construction material applied to the construction field is stroked, to thereby compress and/or level the construction material. The stroking/sweeping member may be arranged adjacent to the output slot and/or may delimit the same, and may form the so-called output region of the coating device container together with the output slot.

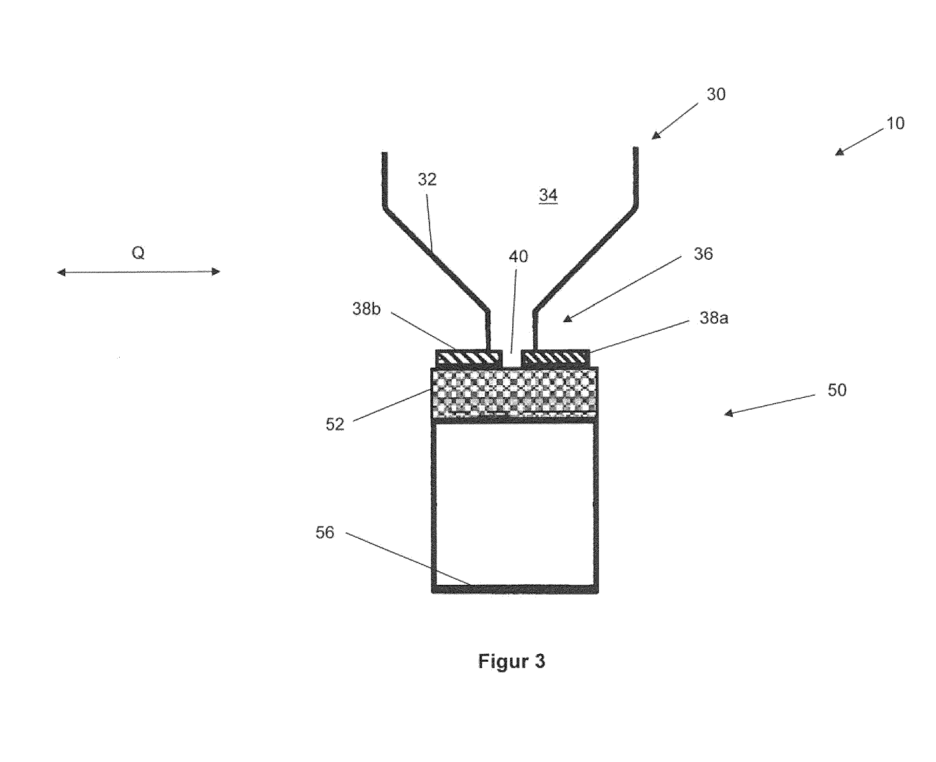

An example of a “slot coating device” is known from DE 10 2009 056 689 A1. See therein, for example, FIGS. 17 to 20.

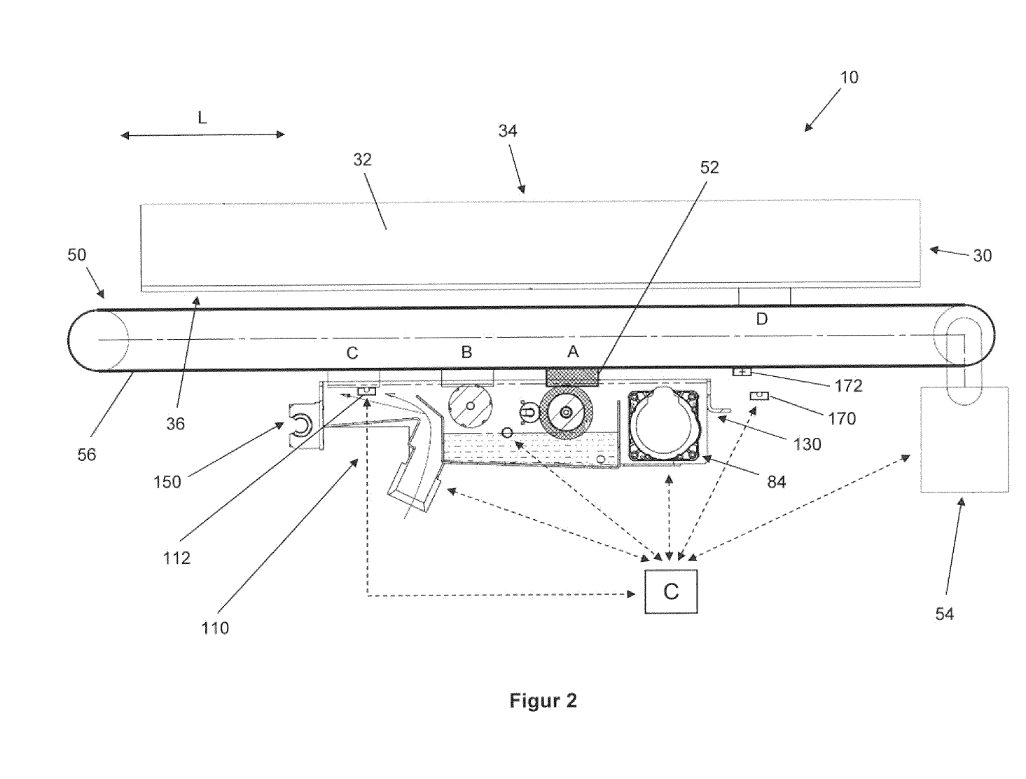

Another example of a “slot coating device” is known from WO 2016/030417 A1 and WO 2016/030375 A2 which both describe a so-called bidirectional coating device. See for example FIGS. 2, 4, 5, 6, 7 of WO 2016/030417 A1.

It is, in addition, known to provide a 3D printer with a coating device cleaning device by means of which construction material adhering to the lower side of the container may be removed and/or wiped off, and/or by means of which the longitudinal slot of the container may be wiped off, in order to release obstructions, if necessary. See DE 10 2009 056 687 A1; therein, for example, see FIGS. 21, 24 and 25.

The coating device cleaning device known from DE 10 2009 056 687 A1 comprises an elongate wiping member which is received at least in part in a construction material collection container underneath the coating device container. The wiping member is supported rotatably and can be driven rotatably by means of a wiping member driving mechanism.

It may be considered as being an object of the present invention to provide a 3D printer and a coating device cleaning method, respectively, by means of which a satisfying quality of the component parts to be manufactured may be guaranteed constantly, for example also for large-dimensioned 3D printers and/or also for a 3D printer/coating device operated in automatic mode (where a lot of construction jobs are carried out without intervention by an operator) and/or for a plurality of construction material mixtures and/or binding agent systems.

For this purpose, the present invention provides a 3D printer according to claim 1 and a method according to claim 22. Further embodiments of the 3D printer according to the invention and of the method according to the invention are described in the respective dependent claims.

According to various aspects of the present invention, a 3D printer having a coating device and such a coating device cleaning device may be provided, by means of which an improved/good cleaning result can be achieved and/or which can be realized easily and/or cost-efficiently, for example also for long coating devices and/or 3D printers of large dimensions, and/or which cleans the coating device reliably, in a fail-safe and efficient way, for example even if the latter is contaminated with firm adhesions/deposits which may, for example, result from a chemical reaction and/or firmly stick to the output region.

According to various aspects of the present invention, a 3D printer is provided with a coating device and a coating device cleaning device. The coating device has a container which defines an inner cavity for receiving particulate construction material, and an (for example elongate) output region for outputting the particulate construction material, and can be moved into a cleaning position in which it is arranged above the coating device cleaning device (and the wiping member thereof, respectively). The coating device cleaning device comprises a wiping member for wiping the output region, which is made from an absorbent material which is configured to absorb a liquid cleaning agent in itself.

Hereby, a liquid cleaning agent (for example a solvent) may be received in the wiping member and may be stored therein for a later/subsequent wiping of the output region, for example at a defined or set amount, so that the output region (for example the stroking surface of a stroking/sweeping member which is arranged adjacent to an output slot of the coating device) may be cleaned by wiping off using a wiping member moistened with a cleaning agent, whereby even firm adhesions/deposits can be removed efficiently.

Deposits on the coating device may, for example, occur when a damp powder material, for example a sand premixed with a liquid binder component (for example a liquid activator) is applied. These deposits may, for example, occur on the so-called stroking/wiping blade, i.e. on the stroking/sweeping member. Contaminations of this type may interfere with/affect the quality of the coating process and may even result in the manufacturing process being stopped. The contaminations may increase with the coating length and the number of layers. Especially in large 3D printers and/or in automatic operation, where many construction jobs are carried out repeatedly without intervention by an operator, this may result in problems and reductions of the construction quality to the point of the construction job being stopped. Nowadays, various cleaning units are known for powder application devices; see the prior art documents discussed hereinbefore. Loose deposits can be removed safely by devices of this type; however, firm and persistent adhesions which are formed during the construction job, for example due to chemical reactions, are harder to clean. Contaminations of this type may, for example, be the result of a so-called evaporation or crystallization of the activator in/on the coating device, an unintended reaction of the activator in/on the coating device with vapors of an already printed binder component, an adhesion of a swirled and previously printed binder component together with the activator to the coating device, etc.

According to the invention, firm and persistent contaminations can be removed using an appropriate solvent which is conveyed to the output region to be cleaned by means of the absorbent wiping member. In addition, the removed contaminations, i.e. the solvent and the dirt solved therein, can be received in the absorbent wiping member reliably, so that the dirt can be removed reliably.

In this respect, the wiping member may, for example, be made from an absorbent, porous sponge or an absorbent textile material, for example an absorbent non-woven material or an absorbent cloth. The porous sponge, for example an open-celled porous sponge, may, for example, be made from a sponge rubber, for example from natural rubber, and may, for example, have a volume weight between 160 and 600 kg/m³, for example greater than or equal to 400 kg/m³. The wiping member may, for example, be provided in the form of a so-called pad or cleaning pad. The wiping member may, for example, comprise a plurality of layers (for example two layers). The wiping member may, for example, comprise a first layer (for example upper/uppermost layer) for wiping the output region and a second layer connected (for example glued) to the first layer for supporting the first layer. The first layer may, for example, be configured to absorb the liquid cleaning agent and the dissolved contaminations in itself. The second layer may, for example, be configured not to absorb any cleaning liquid in itself and/or to provide a contact pressure for pressing the first layer to the output region. The first layer may, for example, be open-pored/open-celled. The first layer may, for example, be made from any one of the above-mentioned materials. The second layer may, for example, be closed-pored/closed-celled, for example in a way not to absorb any liquid. The second layer may, for example, be made from an elastic foam. The second layer may, for example, be connected (for example glued) to a support plate. The support plate may, for example, be attached (for example removably) to a/the support structure (explained below). Even if the use of a multi-layer structure has proved its worth in practice, the invention may just as well be carried out using a one-layered wiping member.

The 3D printer may, for example, be configured to carry out the initially described generative manufacturing method, at least steps (1) to (3).

The cleaning position into which the coating device can be moved and the coating device cleaning device, respectively, may, for example, be arranged adjacent to the construction field.

The coating device cleaning device may, for example, be configured to be stationary, i.e. fixed.

The 3D printer may, for example, comprise a construction space as described initially, in which the component or the components is/are manufactured and which is, for example, defined by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may, for example, at least contribute to forming the construction space. An upper area of the construction space may, for example, be referred to as construction field.

The 3D printer may, for example, comprise a printing device having a print head configured to apply a treatment agent in a controlled way onto a partial area of a previously applied construction material layer. In this respect, the treatment agent may contribute to a (direct and/or subsequent) solidification of the construction material layer in the subarea. For example, the treatment agent may be/include a binding agent, for example a binder component of a multi-component binder. Additionally or alternatively, the 3D printer may, for example, comprise a laser device which is configured to solidify a subarea of a previously applied construction material layer, for example by sintering or melting the construction material in the subarea.

The coating device (or “recoater”) is configured as a so-called “container coating device”, for example as a “slot coating device” (i.e. having a discharge slot). The container coating device may, for example, be movable across a construction field (for example horizontally, for example transverse to its longitudinal direction), so that the particulate construction material can be output onto the construction field through the (for example elongate) output region, to thereby apply a uniform construction material layer over the entire surface of the construction field. The coating device may be elongate, in order to span or cover, for example, the length or width of a rectangular construction field.

The container may, for example, have an elongate shape, in order to span or cover, for example, the entire length or the entire width of a rectangular construction field. The inner cavity of the container may, for example, form a shaft/duct which in cross-section is, for example, tapered in a downward direction (at least in sections) and/or has a funnel shape. The inner cavity for receiving particulate construction material may, for example, lead to the (for example elongate) output region, for example an (elongated) output slot, and may be connected to the same, respectively.

The 3D printer may, for example, comprise a stationary filling station into which the coating device can be moved, in order to fill the container with (fresh) construction material.

The container may, for example, be supplied with construction material by a charging container travelling along with the same.

A distribution device for distributing the construction material may, for example, be received in the optional charging container and/or the container, for example in the form of a distributing worm.

According to various embodiments, the wiping member may for example, be movable from a cleaning device cleaning position in which the wiping member is aligned for wiping the output region into a wiping member cleaning position in which the wiping member is aligned for a cleaning of the wiping member itself, and back into the former position. Hereby, a cleaning of the wiping member itself is made possible, whereby a reliable cleaning of the coating device is made possible. In addition, the wiping member may be infiltrated with cleaning agent (for example solvent in respect of a used binder system for selectively solidifying the particulate material of a respective layer of particulate material) for a subsequent cleaning of the coating device. The coating device cleaning position may, for example, be located vertically above the wiping member cleaning position. The wiping member may, for example, be oriented upwards in the coating device cleaning position and may be oriented downwards in the wiping member cleaning position.

According to various embodiments, the coating device cleaning device may, for example, comprise a cleaning station which is configured to clean the wiping member and infiltrate it with liquid cleaning agent, when the wiping member is positioned in its wiping member cleaning position.

According to various embodiments, the cleaning station may, for example, comprise a cleaning bath of the liquid cleaning agent. An appropriate amount of cleaning agent can be provided by the cleaning bath for cleaning and infiltrating the wiping member. In a possible embodiment, the wiping member may, for example, be passed directly through the cleaning bath or may be plunged at least partially (with its lower side) into it, in order to hereby achieve a cleaning and infiltration of the wiping member. In this context, a degree or amount of cleaning and infiltration can be set (roughly) by the resting time in the cleaning bath, which may be sufficient for a number of applications, in order to constantly ensure a satisfying quality of the components to be manufactured. In addition to or as an alternative to the cleaning bath, one or more nozzles may, for example, be provided, which “spray-wash” the wiping member with cleaning agent in its cleaning position, in order to thereby achieve a cleaning and infiltration of the wiping member.

The cleaning station may, for example, comprise a fluid level sensor by means of which the fluid level of the cleaning bath can be determined, and/or may comprise a sensor by means of which a degree of contamination of the cleaning bath (with dirt dissolved and/or suspended therein, transferred by the wiping member into the bath) can be determined. Thereby, an appropriate cleaning and infiltration of the wiping member and thus, in the end, an appropriate cleaning of the coating device can be achieved.

According to various embodiments, the cleaning station may, for example, further comprise a wiping member cleaning and cleaning agent transmission device which is configured to transport cleaning agent from the cleaning bath to the wiping member and to clean (for example strip off/wipe) the wiping member, when the wiping member is located in its wiping member cleaning position. The wiping member cleaning and cleaning agent transmission device may, for example, comprise or be formed by or consist of a rotatable roller (for example a rotatably driven roller) having an absorbent material (for example a sponge roller), which is configured to absorb liquid cleaning agent in itself. Hereby, on the one hand, the cleaning effect with respect to the wiping member can be improved and, on the other hand, the amount of cleaning agent received in/by the wiping member can be controlled in a better way, in order to ensure a reproducible moisture level in the wiping member and increase process stability. In this respect, it has become evident that in various applications, if the wiping member is too damp, there is a risk that moisture migrates into the output slot of the coating device and/or remains on the coating device (for example on the stroking member/stripping member or the so-called “blade”, for example on the stroking surface of the output region) and the particulate material to be applied agglutinates, which eventually affects the quality of the component to be manufactured. If, on the other hand, the wiping member is too dry, there may be a risk in various applications that the cleaning effect is not sufficient. In addition, it may be important in various applications to keep the wiping member constantly clean, in order to achieve a consistent cleaning effect, in order to ensure a constant quality of the component to be manufactured. For example, the rotatable roller may be rotated in a direction opposed to the movement of the wiping member, in order to clean the wiping member. The rotatable roller may, for example, be arranged between the cleaning bath and the wiping member (for example in a vertical direction), when the latter is in its cleaning position, and may, for example, immerge in the cleaning bath on a lower side thereof and may contact the wiping member on an upper side thereof, to achieve a mechanical cleaning or stripping of the wiping member and transfer dirt from the wiping member to the roller and then from the roller to the cleaning bath.

According to various embodiments, the cleaning station may, for example, comprise a cleaning agent amount adjusting device which is configured to adjust, for example to limit the cleaning agent amount which is transported by the wiping member cleaning and cleaning agent transmission device from the cleaning bath to the wiping member, for example by squeezing liquid out of the absorbent material of the rotatable roller. Hereby, the amount of cleaning agent which is received in/by the wiping member in its cleaning position can be controlled even in a better way. The cleaning agent amount adjusting device may, for example, comprise or be formed by or consist of another roller. The other roller may, for example, contact the rotatable roller, a contact pressure of the other roller being, for example, variably adjustable, so that, for example, depending on the application (for example depending on the particulate material and/or binder system used), an appropriate contact pressure can be set. The other roller may, for example, be capable of being driven by rotational motion in a direction opposite to the rotatable roller.

According to various embodiments, the wiping member may, for example, further be movable into a wiping member conditioning position which is located between the coating device cleaning position and the wiping member cleaning position, and in which a cleaning agent amount which is received in the wiping member is adjustable (for example definitively and/or finely). Hereby, the residual amount of cleaning agent received in/by the wiping member may be adjusted to a value appropriate for cleaning the coating device before the wiping member is (again) moved into its coating device cleaning position. Thereby, it is possible to effectively ensure a satisfying quality of the component to be manufactured because, on the one hand, agglutination is prevented and, on the other hand, an appropriate cleaning can be ensured.

According to various embodiments, the coating device cleaning device may, for example, further comprise a conditioning station which is configured to adjust, for example to reduce the cleaning agent amount which is received in the wiping member when the wiping member is in its wiping member conditioning position, for example by driving cleaning agent received in the wiping member out of the wiping member by carrying along/discharging cleaning agent in a fluid stream and/or by thermal driving out of cleaning agent and/or by mechanical driving out of cleaning agent.

According to various embodiments, the conditioning station may, for example, comprise a stripping and/or squeezing device where the wiping member can be stripped off and/or cleaning agent can be squeezed out of the wiping member, to discharge a part of the cleaning agent which is received in the wiping member from the wiping member, wherein the stripping and/or squeezing device may, for example, be arranged above the cleaning bath or may be otherwise in fluid connection with the same, so that the cleaning agent stripped off and/or squeezed out of the wiping member can be returned to the cleaning bath, and/or comprises a roller where the wiping member can be squeezed. For example, the stripping and/or squeezing device may comprise or be formed by or consist of a roller, for example an impression roller. Alternatively or in addition, a stripping blade may, for example, be provided.

According to various embodiments, the conditioning station may, for example, comprise a fluid stream supply device which is configured to direct a fluid stream (for example a gas stream, for example an air stream) onto the wiping member (or rather to “blow” a fluid stream on the latter), to discharge, by means of the fluid stream, a part of the cleaning agent received in the wiping member from the wiping member, wherein the fluid stream supply device may, for example, further be configured to set a temperature of the gas stream. The fluid stream supply device may, for example, be provided together with the stripping and/or squeezing device, for example in the direction of movement of the wiping member behind the stripping and/or squeezing device or rather downstream thereof. It is, however, also possible to provide only one of the fluid stream supply device and the stripping and/or squeezing device. A fine/precise/appropriate adjustment of a remaining amount of cleaning agent in the wiping member can be realized by means of the fluid stream supply device in various applications. The fluid stream supply device may, for example, comprise a blower and/or a fan, an optional fluid directing structure (for example in the form of one or more deflector plates, etc.) as well as an optional heating device.

The conditioning station and the cleaning station may, for example, be formed integrally and/or may be accommodated in a common housing.

According to various embodiments, the 3D printer may, for example, further comprise a sensor device by which an amount of cleaning agent received in the wiping member can be determined. The sensor device may, for example, comprise one or more capacitive sensors and/or one or more electrolytic sensors and/or one or more resistive sensors. The sensor device may, for example, be configured to determine the amount of cleaning agent received in the wiping member when the wiping member is located in one or more or each of the following positions selected from the wiping member conditioning position, for example in the flow path of the fluid stream supply device, the coating device cleaning position and the wiping member cleaning position. In this context, it is also possible to mount a sensor in the wiping member itself. It is, for example, possible to determine by means of the sensor device whether it is appropriate to carry out an (for example another) infiltration of the wiping member with cleaning agent or whether it is appropriate to remove (for example more) cleaning agent from the wiping member or whether it is appropriate not to carry out any of the aforementioned actions (for example because the target moisture/target cleaning agent amount of the wiping member has been achieved). Hereby, the amount of cleaning agent received in/by the wiping member can be adjusted in a particularly precise way to a value appropriate for cleaning the coating device before the wiping member is moved (again) in its coating device leaning position. Thus, a satisfying quality of the component to be manufactured can be ensured, because, on the one hand, agglutination can be prevented, and, on the other hand, an appropriate cleaning can be ensured.

According to various embodiments, the 3D printer may, for example, further comprise a control which is connected to the sensor device and which may be configured to prompt, on the basis of a value received from the sensor device, which is representative of the amount of cleaning agent received in the wiping member, an adjustment of a residual amount of cleaning agent in the wiping member (for example a drying of the wiping member to a residual moisture and/or residual amount of cleaning agent), for example by means of driving/controlling the conditioning station, for example the fluid stream supply device and/or the stripping and/or squeezing device thereof, and/or driving/controlling a driving device of the wiping member and/or driving/controlling the cleaning station, for which purpose the control may further be connected to the conditioning station, for example the fluid stream supply device and/or the stripping and/or squeezing device thereof, and/or the driving device for the wiping member and/or the cleaning statin. The control may, for example, set a residual amount of cleaning agent in the wiping member depending on a used construction material and/or binder system and/or cleaning agent and/or a type of the absorbent material and/or a cleaning interval of the coating device and/or a degree of contamination of the coating device, for which purpose for example corresponding maps or tables may be stored in the control.

It is, for example, possible to control by means of the control whether and/or when the coating device is to be cleaned. For example, it may be considered to carry out a cleaning after a particular number of particulate material layers having been applied onto the construction field and/or during the selective solidification of a previously applied layer (for example by means of a printing device). The control may, for example carry out the (entire) cleaning process in a way controlled by a software. According to various embodiments, the 3D printer may, for example, comprise a sensor (“contamination sensor”) which detects a contamination and/or clogging of the output region of the coating device (for example optically), for example including a degree of contamination and/or clogging. In this case, the control may, for example, be configured to prompt, based on a signal of the sensor, a cleaning of the coating device, and/or to select and carry out a corresponding pattern of movement (see below) according to the degree of contamination.

According to various embodiments, a control/control unit may for example be provided (for example the above-mentioned control which is connected to the sensor) which is configured to control the driving device (for example an electric motor thereof) according to different wiping member movement patterns. In other words, various movement patterns may be stored in the control. A first movement pattern may, for example, comprise/contain a permanent movement of the wiping member in one direction. According to a second movement pattern, the wiping member may, for example, alternately be moved to the left and to the right. Moreover, two movement patterns may, for example, differ in that the wiping member is moved at different speeds. Providing different patterns of movement makes it possible to carry out a respectively appropriate cleaning in an efficient way. The control may, for example, choose a respective movement pattern in accordance with a construction material used and/or a degree of contamination and/or a solvent used and/or a cleaning interval (i.e., a time lag between two successive cleanings).

According to various embodiments, the coating device cleaning device may, for example, further comprise a driving device for moving the wiping member, which is configured to move the wiping member relative to the output region for a cleaning thereof (for example in a rectilinear/linear way), when the coating device is positioned above the coating device cleaning device, and/or to move the wiping member between the coating device cleaning position and the wiping member cleaning position, and optionally the wiping member conditioning position

The driving device may, for example, comprise a motor, for example an electric motor, which is, for example, connected to a control, for example the above-mentioned control. According to various embodiments, the driving device may, for example, comprise a (for example elongate) carrier structure, for example in the form of a belt or strap, which can, for example, be driven by the motor and to which the wiping member is attached. The driving device may, for example, further comprise two or more deflection means (for example in the form of (belt) pulleys and/or rolls), about which the (elongate) carrier structure is wound/laid/guided, so that the carrier structure and thus the wiping member is movable relative to the coating device by driving at least one of the deflection means (for example by means of an electric motor). For example, a first portion of the belt or strap may extend at a (slight) distance to the output region substantially in the longitudinal direction thereof and/or may be arranged vertically below the output region and/or may be configured in a straight line and/or may extend parallel to the output region and/or may be arranged in a height direction between the output region and the second portion, which again may be formed in a straight line and/or may extend parallel to the output region and/or the first path section.

According to various embodiments, the wiping member may, for example, be releasably attached to the carrier structure, for example by means of a quick fastener. Hereby, an appropriate wiping member can be attached to the carrier structure depending on, for example, the solvent and/or the binder system and/or the particulate material. In addition, it is made possible to quickly replace/exchange a worn wiping member without a replacement/exchange of the carrier structure being necessary.

According to various embodiments, the driving device may, for example, be configured to move the wiping member into a lowered position in which a collision with the coating device is avoided, wherein the wiping member is, for example, located in the lowered position in the wiping member cleaning position and/or in the wiping member conditioning position, whereas it is, for example, arranged in an elevated position in the coating device cleaning position. In other words, the wiping member may be configured to be movable in a height direction, wherein it is, for example, arranged higher in the coating device cleaning position than in the lowered position. Hereby, a compact configuration of the 3D printer is made possible, given that the coating device cleaning device may be arranged near the construction field or may rather be moved near the same without affecting the coating device in its usual operation (for example during the coating travels between a first and a second cleaning). In other words, it is thus possible to move the coating device without any collision across the cleaning device.

According to various embodiments, the driving device may, for example, be configured to move the wiping member for a cleaning of the output region along the same, when the coating device is positioned above the coating device cleaning device, or when the wiping member is located in its coating device cleaning position. This means that the wiping member can be movable by means of the driving device for cleaning the output region along the same (i.e., substantially in a longitudinal direction thereof and/or substantially along the length (of the output region), for example substantially along the entire length or a portion thereof, which portion is, for example, greater than or equal to half of the entire length, for example greater than or equal to ¾ of the entire length, for example greater than or equal to ⅚ of the entire length) even if the coating device is located above the coating device cleaning device. Hereby, the output region is wiped by the wiping member in a longitudinal direction, other than in the initially mentioned state of the art where the output region is wiped by a rotating wiping member in a transverse direction. According to various embodiments, wiping the output region (for example the at least one stroking surface) in a longitudinal direction can lead to an effective and/or efficient cleaning thereof, for example with a cleaning effect improved over the initially mentioned conventional cleaning device and/or with a resistance to be overcome by the driving device which is reduced over the initially mentioned conventional cleaning device. According to various embodiments, wiping the output region (for example the output slot and/or the at least one stroking surface) in a longitudinal direction can help realize an appropriate cleaning thereof in a simple and cost-effective way, for example also for long coating devices and long output regions, respectively. In this respect, the elongate (for example roller-shaped) wiping member required for the conventional cleaning device may, for example, be dispensed with according to various aspects of the present invention, and/or the length of the wiping member may be reduced, and the driving device of the wiping member may be configured to be less strong, given that the resistance to be overcome can be reduced. The driving device may, for example, be configured to move the wiping member along the output region in a linear/rectilinear way. In other words, the wiping member may pass along/wipe the output region in a linear movement along the longitudinal direction thereof, in order to clean it.

According to various embodiments, the driving device may, for example, be configured to move the wiping member along a circulating path (for example a closed path/trajectory, for example comprising two straight sections and two curved, for example semicircular sections) which extends with a first path section along the output region (i.e., substantially in a longitudinal direction thereof and/or substantially along the length (of the output region), for example substantially along the entire length or along a substantial section thereof), when the coating device is in the coating device cleaning position. According to this embodiment, the wiping member does thus not perform any proper rotational movement by itself about its own rotational axis, but circulates around an external point. The first path section may, for example, be configured in a straight line and/or may extend parallel to the output region or at/in the same. Moving the wiping member along a circulating path is a possible way of moving the wiping member to the above-described lowered position in the meantime. In this respect, the circulating path may, for example, comprise a second path section which is arranged vertically below the first path section and vertically below the output region; in this respect, the second path section may, for example, be configured in a straight line as well, and/or may extend parallel to the first path section. When the wiping member is located at the second path section, it may, for example, be oriented downward, i.e. averted from the output region, whereas it is oriented upward when it is located on the first path section.

According to various embodiments, the output region may, for example, comprise an elongate output slot and/or at least one (for example one or two) elongate stroking surface(s) (for example formed by a stroking member or a stroking blade) configured to stroke construction material output from the container, to thereby level and/or compress the output construction material, wherein, for example, the at least one elongate stroking surface can be wiped off by the wiping member. For example, altogether two stroking surfaces may be provided in a transverse direction on different sides of the output slot. The wiping member may, for example, have an extension in a width direction extending crosswise to the longitudinal direction of the output slot/stroking surface, which is greater than or equal to that of the elongate stroking surface, for example greater than or equal to that of the output region. The at least one stroking surface may, for example, be provided by a stroking member, which may, for example, be provided in the form of a so-called stroking bar/strip and/or stroking blade, for example by a portion of the stroking member oriented in a downward direction, which may, for example, project/protrude downward, for example in a stepped way. For example, the (respective) stroking surface may be configured to be planar and/or in strip shape. The one or more stroking surfaces and stroking members, respectively, may, for example, be arranged adjacent to the output slot and/or may delimit the same, for example each in a transverse direction. For example, the output slot may be arranged in a transverse direction between two stroking surfaces and stroking members, respectively. Thereby, the coating device can be formed and/or operated as a bidirectional coating device, the stroking surface located at the rear in the direction of travel being respectively active. In this respect, at least the respectively active stroking surface (for example the entire coating device) may for example be tilted to adjust a so-called set angle of the stroking surface with respect to the construction field and thereby a degree of compression of the particulate material. The one or more stroking members may, for example, be fixed to and/or suspended from a carrier structure of the coating device, for example together with an optional closing device for selectively closing the output slot. Said carrier structure may, for example, extend transverse to the direction of movement of the coating device and/or in a longitudinal direction of the coating device. The container may be fixed to the carrier structure as well, for example separately from the optional at least one stroking member and/or the optional closing device.

For example, the (elongate) output region and/or the (elongated) output slot and/or the one or more (elongate) stroking surfaces may be directed downward, for example toward the construction field. The (elongate) output region and/or the (elongated) output slot and/or the one or more (elongate) (effective) stroking surfaces may have a first extension in a longitudinal direction and a second extension in a transverse direction, the first extension being greater than the second extension, for example at least by the factor 2, 3, 4, 5, 6, 7, 8, 9, 10, 11, 12, 13, 14, 15, 16, 17, 18, 19, 20 or more. For example, the (elongate) output region and/or the (elongated) output slot and/or the respective stroking surface may substantially have a rectangular shape and/or a strip shape when viewed from above.

According to various embodiments, the coating device cleaning device may, for example, comprise a plurality of wiping members which are, for example, movable together into a respectively lowered position, to avoid a collision with the coating device. This allows for an efficient cleaning.

According to various embodiments, the 3D printer may, for example, further comprise a sensor (for example a position sensor) which is configured to detect a position of the wiping member, and/or a sensor which is configured to detect a filling level of the cleaning bath. For example, with respect to the former sensor, a target to be detected by the sensor may be attached to the wiping member itself and/or may be formed by the same and/or may be attached to the above carrier structure and/or may be formed by the same. A respective sensor may, for example, be connected to a control, for example to the above-mentioned control. The control may, for example, be configured to control the driving device (for example an electric motor thereof) according to a position signal received from the position sensor. Hereby, it is for example possible to make sure that cleaning takes place in a reliable way and as desired, and/or that the wiping member is arranged in the above-described lowered position after cleaning.

According to various embodiments, the 3D printer may, for example, further comprise a printing device having a print head. Alternatively or in addition, the 3D printer may, for example, comprise a laser device.

According to various aspects of the present invention, a method is provided for cleaning a coating device of a 3D printer, the coating device comprising a container which defines an inner cavity for receiving particulate construction material, and has an output region for outputting the particulate construction material, and wherein the method comprises:

moving the coating device into a cleaning position in which the coating device is arranged (for example vertically) above a coating device cleaning device comprising a wiping member which is made from an absorbent material configured to absorb a liquid cleaning agent in itself, and

wiping the output region by the wiping member in a state in which the wiping member is moistened (for example infiltrated and/or soaked) with a liquid cleaning agent.

The information provided above with respect to the 3D printer shall apply analogously to the method for cleaning a coating device of a 3D printer.

According to various embodiments, the method for cleaning a coating device of a 3D printer may, for example, further comprise:

moving the wiping member to a cleaning station and cleaning the wiping member and/or infiltrating the wiping member with cleaning agent in the cleaning station, and/or

moving the wiping member to a conditioning station and adjusting a cleaning agent amount received in the wiping member, in the conditioning station, for example after moving the wiping member to the cleaning station and/or before wiping the output region using the wiping member, for example depending on a used construction material and/or binder system and/or cleaning agent, for example to reduce the cleaning agent amount, for example by driving cleaning agent out of the wiping member by carrying along/discharging cleaning agent in a fluid stream and/or by thermal driving out of cleaning agent and/or by mechanical driving out of cleaning agent, and/or

determining an amount of cleaning agent received in the wiping member, for example using a sensor, for example after moving the wiping member to the cleaning station and/or before wiping the output region using the wiping member, and/or

moving the wiping member into a lowered position to avoid a collision with the coating device, after wiping the output region using the wiping member, and/or

replacing the wiping member with another wiping member once the wiping member is worn out or in adaptation to a used construction material and/or binder system and/or cleaning agent.

According to various embodiments, in the method for cleaning a coating device of a 3D printer, for example,

the output region may have an elongate shape and wiping the output region using the wiping member may substantially be carried out in a longitudinal direction of the output region, and/or

moving the wiping member may take place on a closed trajectory, and/or the method of cleaning the coating device may take place in a software-controlled way (for example the entire method except for a possible exchanging of the wiping member).

Apart from that, the information provided above with respect to the 3D printer applies analogously to the method.

In addition, the following applies both to the method and to the 3D printer or 3D printers:

Particulate construction material within the meaning of this application may be understood as a construction material comprising at least one kind of particulate material (for example (grains of) sand, for example foundry sand, and/or metal particles and/or particles of synthetic material). Several different types of particulate material may be included in the construction material as well, such as a mixture of new sand and recycled sand or a mixture of fine sand and coarse sand or a mixture of two different types of sand. Moreover, the construction material may comprise at least one liquid component, for example a binder component, for example an activator, and/or one or more solid and/or liquid additives. In case that the construction material contains a binder component, another binder component, such as furan resin, may selectively be printed onto a previously applied construction material layer by means of a printing device, so as to solidify this layer in a predetermined area. Depending on the component to be manufactured, for example a casting mold or a foundry core, a construction material composition specifically prepared for this purpose may be used. In this respect, the construction material composition may be defined by the number of components used as well as by the respective type and the respective share of components contained in the construction material (mixture). In this respect, the trickle or flow behavior of the construction material as well as reactivity or the risk of chemically induced adhesions to the coating device may vary considerably depending on the composition of the construction material. Correspondingly, the temporal occurrence and/or the degree of contamination and thus a necessary cleaning may vary according to the composition of the construction material used.

According to various embodiments, the coating device may, for example, be provided with a vibration device by means of which the particulate material received in the inner cavity may be vibrated to influence, for example to support, the flow or trickle behavior of the particulate construction material or the discharge of the particulate construction material from the output region. A vibration device of this type may, for example, be formed by a shaking device by means of which at least a wall portion of the container is vibrated or exposed to a shaking motion to influence the discharge of the particulate construction material. According to various embodiments, also a particulate construction material having a poor trickle or flow behavior may be vibrated appropriately using a vibration device, and/or a wall portion of a container receiving the construction material may be exposed to an appropriate shaking motion using a shaking device.

According to various embodiments, the coating device may, for example, be provided with a labyrinth structure inside the container, which may prevent the construction material from flowing out/escaping when the coating device stands still, and/or with a closing device which enables a selective closing of the output region (for example of the output slot) and comprises, for example, a closing member attached to the coating device.

Exemplary but non-limiting embodiments of the present invention are shown in the Figures and are hereinafter described in detail.

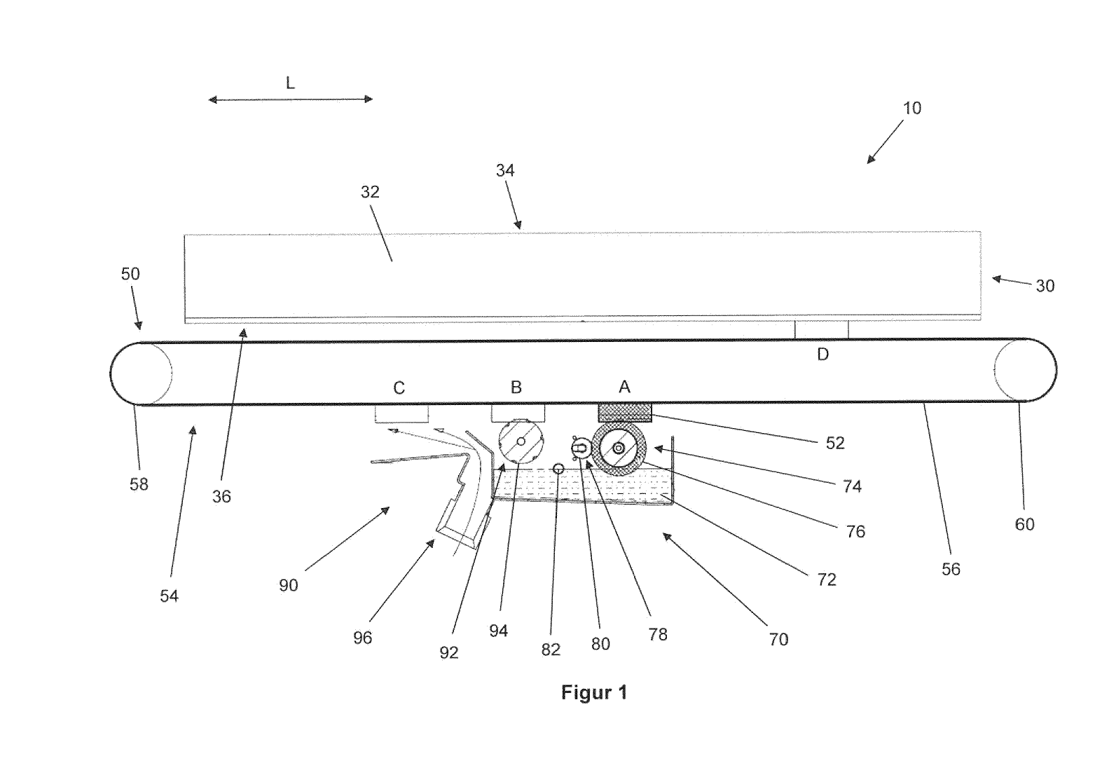

FIG. 1 and FIG. 2 show lateral views of a coating device and a coating device cleaning device of a 3D printer according to an embodiment of the present invention, parts of the coating device cleaning device having been omitted in FIG. 1.

FIG. 3 shows a cross-sectional view of the coating device and the coating device cleaning device according to the embodiment shown in FIG. 1 and FIG. 2, the wiping member being arranged in its coating device cleaning position.

In the following detailed description, reference is made to the enclosed Figures which are incorporated therein and in which specific embodiments are shown by way of illustration, according to which the invention can be performed. In this respect, the terms “up”, “down”, “front”, “rear”, etc. are used with reference to the orientation in the described Figures. As components of embodiments may be positioned in a number of different orientations, the terminology indicating the different directions serves for illustration and shall not be restrictive in any way.

It shall be understood that other embodiments may be used and structural or logical changes may be made without deviating from the scope of protection of this invention. It goes without saying that the features of the various exemplary embodiments described herein may be combined unless specified otherwise. Thus, the following detailed description should not be understood in a restrictive sense and the scope of protection of the invention shall be defined by the attached claims.

In this description, terms such as “connected”, “attached” and “coupled” may be used to describe both a direct and indirect connection, a direct or indirect attachment and a direct or indirect coupling.

In the Figures, identical or similar members are provided with identical reference numbers where appropriate.

FIG. 1 and FIG. 2 show a simplified lateral view of a coating device 30 which, for cleaning its output region 36, is moved into a cleaning position in which it is arranged vertically above a coating device cleaning device 50; in this respect, parts of the coating device cleaning device 50 have been omitted in FIG. 1 for the sake of clarity (such as the electric motor of the driving device, various sensors, and the control, which are all shown in FIG. 2). The coating device 30 and the coating device cleaning device 50 form part of a 3D printer 10, and the cleaning position may, for example, be located near a construction field of the 3D printer 10, which construction field is not shown.

As shown herein, the coating device 30 comprises a container 32 which defines an inner cavity 34 for receiving particulate construction material. Cf. also FIG. 3. In addition, the coating device 30 shown herein has an output region 36 for outputting the particulate construction material onto a construction field. The output region 36 may, for example, be elongate.

The coating device 30 shown herein and the container 32 shown herein each may, for example, have an elongated shape, i.e. an extension in the longitudinal direction L which is greater than an extension in the transverse direction Q (also see FIG. 3). The same applies to the output region 36 which may also have an extension in the longitudinal direction L which is greater than its extension in the transverse direction Q. For example, the output region 36 in FIG. 1 and FIG. 2 may extend substantially over the entire length of the container 32.

The coating device cleaning device 50 shown herein comprises a wiping member 52. The coating device cleaning device 50 may, for example, comprise an optional driving device 54 for moving the wiping member 52 (for example using an electric motor). The wiping member may, for example, be fixed to a carrier structure 56 of the driving device 54, for example releasably. The carrier structure 56 may, for example, be configured in the form of an endless strap. The wiping member 52 is made from an absorbent material which is configured to absorb a liquid cleaning agent in itself. Here, a wiping member 52 is shown by way of example, which is configured as a square-shaped, absorbent, porous sponge (also see FIG. 3). The shape and the material of the wiping member are, however, not limited thereto. The wiping member may, for example, have the shape of a roller or of a prism. Moreover, the wiping member may, for example, be an absorbent non-woven material. The coating device cleaning device 50 may, for example, also comprise more wiping members 52 of this type, which are for example fixed to/arranged on the carrier structure 56 along a portion of the carrier structure at regular intervals. The wiping member 52 may, for example, be fixed to the carrier structure 56 by means of a quick fastener (not shown).

The output region 36 of the coating device 30 can be cleaned effectively and efficiently due to the fact that the wiping member 52 is made from an absorbent material which is suited to absorb a liquid cleaning agent in itself, especially when the previously absorbed cleaning agent absorbed is being used.

The driving device 54 may, for example, be configured to move the wiping member 52 for cleaning the output region 36 along a circulating path which extends with a first path section along the output region 36 when the coating device 30 is in the coating device cleaning position, so that wiping the output region 36 may substantially take place in the longitudinal direction of the output region 36. The first path section may, for example, be formed to be linear. A second path section which may, for example, also be formed to be linear, may, for example, extend below the first path section.

In addition, the driving device 54 may, for example, be configured to reciprocate the wiping member 52 between a coating device cleaning position, a wiping member cleaning position and a wiping member conditioning position (see below).

The driving device 54 may, for example, further comprise a first and a second disk or deflection pulley 58, 60, one of which being capable of being driven, for example by means of an electric motor, to move the carrier structure 56 and thereby the wiping member 52.

The wiping member 52 shown in FIG. 1 is located in a position A which corresponds to a wiping member cleaning position. In the wiping member cleaning position, the wiping member 52 may, for example, be cleaned and infiltrated with liquid cleaning agent. The wiping member cleaning position does not necessarily have to correspond to a single position A, but may correspond to a plurality of positions in which the cleaning member is cleaned and infiltrated with liquid cleaning agent.

The wiping member cleaning position may, for example, be characterized in that the wiping member is located on/in a cleaning station 70 by means of which the wiping member is cleaned and infiltrated with liquid cleaning agent. For this purpose, the cleaning station may, for example, comprise a cleaning bath 72 and a wiping member cleaning and cleaning agent transmission device 74 which may, for example, be configured as a rotatable roller 76. The curved surface area of the rotatable roller 76 may, for example, be made from the same absorbent material as the wiping member 52. The cleaning bath 72 may, for example, contain an organic solvent or an aqueous solution of a surfactant.

The rotatable roller 76 may, for example, be arranged in a way that part of the curved surface area of the rotatable roller 76 is located in the cleaning bath 72 or immerges therein, so that the shell of the roller 76 can absorb cleaning agent from the cleaning bath 72. The rotation axis of the roller 76 and the plane formed by the liquid surface of the cleaning bath 72 may, for example, be parallel. The part of the curved surface area of the roller 76 located opposite said one part of the curved surface area of the roller 76 may, for example, contact the wiping member 52 or may, for example, touch it, so that the shell can pass the previously absorbed cleaning agent to the wiping member 52 when the roller has rotated by 180°.

The roller 76 may, for example, be driven by means of a drive 84 (for example by means of an electric motor). The roller 76 may, for example, be capable of being driven by rotational movement in both rotation directions. For example, the roller 76 may be driven by rotational movement in a direction opposed to the direction of movement of the wiping member 52. I.e., when the wiping member 52 in FIG. 1 and in FIG. 2, respectively, is moved in a direction from position A to position B, the roller may preferably be rotated clockwise.

In order to clean the wiping member 52 and infiltrate it with cleaning agent, the side of the wiping member 52 which is used for cleaning the output region 36 may, for example, be moved across the roller 76; in this context, the roller 76 may, for example, be moved in a direction opposite to the direction of movement of the wiping member 52. Thereby, the surface of the wiping member 52 can be cleaned mechanically by friction, and fresh cleaning agent can be transferred from the cleaning bath 72 to/in the wiping member. In addition, the roller 76 can be cleaned by the cleaning agent of the cleaning bath 72. Depending on the contamination degree of the wiping member 52, the wiping member 52 may, for example, be reciprocated across the roller 76 several times. For this purpose, the driving device 54 may, for example, be configured to move the carrier structure 56 in both directions.

In addition, the 3D printer may, for example, comprise a sensor 82 which is configured to detect a filling level of the cleaning bath 72. The filling level of the cleaning bath helps, for example, to determine whether the curved surface area of the roller 76 immerges into the cleaning bath 72. Hence, a cleaning of the wiping member 52 and a transfer of cleaning agent to/in the wiping member 52 or rather an infiltration of the wiping member with cleaning agent by means of the roller 76 can be ensured.

In order to avoid an excessive infiltration of the wiping member 52 with cleaning agent, the cleaning station 70 may, for example, comprise a cleaning agent amount adjusting device 78. This device may, for example, be provided in the form of a roller 80, the rotation axis of which may, for example, be arranged parallel to the rotation axis of the roller 76, and which may, for example, contact or touch the rotatable roller 76, so that a part of the liquid may be squeezed out of the absorbent material of the rotatable roller 76 again. The roller 80 may, for example, be rotatable (for example in a direction opposite to the roller 76), and may, for example, be arranged such that the contact or touch point of the two rollers 76 and 80 is between the site where the curved surface area of the rotatable roller 76 immerges in the cleaning bath and the site where the curved surface area of the roller 76 touches the wiping member 52. The roller 80 may, for example, be configured in such a way the rotation axis of the roller 80 can be displaced back and forth or be adjusted in the direction of the rotation axis of the roller 76. Thereby, the contact pressure of the roller 80 with respect to the roller 76 can be set, whereby the amount of cleaning agent squeezed out of the roller 76 can be controlled.

The coating device cleaning device 50 may, for example, further comprise a conditioning station 90 which may be configured to adjust the residual cleaning agent amount absorbed in the wiping member 52. For this purpose, the wiping member 52 may, for example, be moved to its wiping member conditioning position after having been cleaned and infiltrated with cleaning agent in the wiping member cleaning position. The positions B and C show two selected positions of the wiping member conditioning position. I.e., the wiping member conditioning position may be formed by a plurality of positions which are explained below in more detail.

The (residual) amount of cleaning agent to be received in the wiping member 52 may, for example, vary as a function of a used construction material and/or binder system and/or cleaning agent and/or degree of contamination and/or degree of cleaning, etc., and may, for example, be set by a control.

In general, a cleaning of the coating device 30 or of the output region 36 thereof may be achieved by the cleaning agent absorbed in the wiping member 52. Consequently, the cleaning effect of a wiping member 52 in which a too little amount of cleaning agent is absorbed may be insufficient. However, a too large amount of cleaning agent may result in that a part of the cleaning agent adheres to the coating device or to its output region 36 when the coating device 30 or its output region 36 is wiped, which may result in that the construction material output by the coating device agglutinates. It may therefore be preferred to set a desired amount of cleaning agent received in the wiping member 52.

In return, the conditioning station 90 may, for example, comprise a stripping and/or squeezing device 92 where the wiping member 52 can be stripped and/or cleaning agent can be squeezed out of the wiping member 52, to discharge a part of the cleaning agent which is received in the wiping member from the wiping member. The stripping and/or squeezing device 92 may, for example, be a roller 94 which is, for example, rotatable. The roller 94 may, for example, be arranged in a way to touch the wiping member 52 when the wiping member is moved across it (position B in FIGS. 1 and 2), so that a part of the cleaning agent absorbed in the wiping member is squeezed out of it. The roller 94 may, for example, be arranged above the cleaning bath 72, so that cleaning agent stripped off/squeezed out of the roller can be returned into the cleaning bath 72.

The conditioning station 90 may, for example, further comprise a fluid stream supply device 96 which may be configured to direct a fluid stream onto the wiping member 52, to discharge a part of the cleaning agent absorbed in the wiping member 52 from the wiping member 52 by means of the fluid stream. For example, the wiping member 52 may first be stripped/squeezed out on the roller 94 and may then be further treated by means of the fluid stream supply device 96, until a desired amount of cleaning agent is received/present in the wiping member 52. For this purpose, the wiping member 52 may, for example, be moved to the illustrated position C and may there be treated by means of a fluid stream. The fluid stream supply device 96 may, for example, comprise a fluid stream thermoregulation device (not shown) to set the temperature of the fluid stream. The temperature of the fluid stream may, for example, be set to between 25 to 200° C.

In order to determine the amount of cleaning agent received in the wiping member 52, the 3D printer 10 may for example further comprise a sensor device 110 having one or more sensors 112, which may be configured to determine the amount of cleaning agent received in the wiping member 52. Capacitive sensors, electrolytic sensors or resistive sensors may, for example, be used as sensors 112. As shown in FIG. 2, the sensor 112 may, for example, be located in the wiping member conditioning station. The sensor 112 may, for example, be arranged in a way to scan the wiping member 52 when the wiping member is treated by the fluid stream supply device 96. It is thereby possible to supply the wiping member 52 with a fluid stream until the desired amount of cleaning agent received in the wiping member is achieved. Alternatively or in addition thereto, a sensor may, for example, be integrated in the wiping member 52. Alternatively or in addition thereto, a sensor may, for example, also be arranged following or behind the fluid stream supply device 96, i.e. in FIGS. 1 and 2 on the left-hand side of the fluid stream supply device 96. In addition, a sensor may, for example, be arranged on/in the coating device cleaning station 70 alternatively or in addition thereto.

The 3D printer may, for example, further comprise a control C which is, for example, connected to the sensor device 110 and the sensor 112, respectively, the driving device 54, the conditioning station 90, the fluid stream supply device 96, the drive 84 and/or the sensor 82. The control may, for example, be configured to prompt an adjustment of a residual amount of cleaning agent in the wiping member 52 based on a value received from the sensor 112, which is representative of the amount of cleaning agent received in the wiping member 52.

For this purpose, the control may, for example, carry out the movement of the wiping member between the positions A, B, and C by driving/controlling the driving device 54. For example, when the sensor detects in position C that the residual amount is too low, the wiping member 52 may be moved to the roller 76 again, in order to be infiltrated by it with cleaning agent once again. Alternatively, the control C may, for example, stop the fluid stream when the wiping member is located in position C and it is detected that the wiping member comprises the preferred residual amount of cleaning agent. It may, for example, be preferred that the wiping member is first infiltrated with a sufficient amount of cleaning agent and is then conditioned in a way that another infiltration is not necessary.

The coating device cleaning device 50 may, for example, further comprise a sensor 170 which is configured to detect a circulation position of the carrier structure 56 and thus a position of the wiping member 52. For this purpose, a sensor target 172 may be arranged on/attached to the carrier structure 56. Alternatively or in addition thereto, the wiping member 54 itself may, for example, comprise a sensor target 172 of this type.

The coating device cleaning device 50 shown herein may, for example, further comprise an optional housing 130 in which the cleaning station 70 and the conditioning station 90 are received and arranged, respectively; in this context, an optional fixing device 150 may, for example, be connected to the housing or may be arranged thereon, in order to fix the housing or the cleaning station 70 and the conditioning station 90 in a desired position.

As shown in FIG. 3, the output region 36 may, for example, comprise an elongate output slot 40 and/or at least one elongate stroking surface which may be configured to stroke construction material output from the container 32, to thereby level and/or compress the output construction material. The coating device 30 may, for example, be configured as a bidirectional coating device which is able to apply a layer in both directions onto a construction field (i.e., during a journey to the left and to the right and/or during a journey and a return journey across the construction field), for which purpose the coating device may be provided with two elongate stroking surfaces which here may be formed by two bar-shaped stroking members 38a and 38b or rather by their respective lower side. The two stroking members 38a, 38b may, for example, be arranged in a transverse direction of the coating device (in which direction the coating device can be moved horizontally across a construction field) on opposed sides of the output slot 40, and may delimit the same in a transverse direction. It should be understood that the coating device may, for example, also be configured as a unidirectional coating device having, for example, merely one stroking surface and/or one stroking member. It is also possible to realize the coating device, for example, without stroking surface/stroking member.

As further illustrated by FIG. 3, the wiping member 52 may underlap the output region 36 in the transverse direction thereof for example entirely, i.e. both the output slot 40 and the two stroking surfaces which may be formed by the lower side of the respective stroking member 38a, 38b facing the construction field.

FIGS. 1 and 2 illustrate, amongst others, a state or a position A which is a lowered position, where the wiping member is, in addition, oriented in a downward direction, to clean the wiping member at the cleaning station and infiltrate it with cleaning agent. FIG. 3 illustrates a state in which the wiping member is in an elevated position and oriented upward (cf. the state or the position D in FIGS. 1 and 2) to clean the output region.

In normal operation of the 3D printer 10, the wiping member may be moved into any lowered position and may be oriented in a downward direction, so that the coating device 30 may be moved into and across the cleaning position without collision. If the coating device 30 or its output region 36 is to be cleaned, it may be moved to a position above the cleaning device 50 and may be stopped. Then, the drive 54 may be turned on or one of the two disks/deflection pulleys 58, 60 may be rotated/moved (for example by the control C), so that the wiping member 52 in which an appropriate amount of cleaning agent is received or which is infiltrated with an appropriate amount of cleaning agent moves from its lowered position upward. A desired cleaning effect may be achieved by an appropriate movement pattern of the wiping member 52 or the carrier structure 56 relative to the coating device. For example, the carrier structure 56 may be moved permanently in one direction or the carrier structure 56 may be moved alternately to the left and to the right, when the wiping member is in the elevated position D oriented upward. After the output region 36 having been cleaned sufficiently, the wiping member may be moved downward again, to enable the wiping member 52 to be cleaned and supplied with new cleaning agent and to enable the coating device 30 to be moved across the cleaning position without collision. An intermediate cleaning and infiltration with new cleaning agent of the wiping member during a cleaning process of the coating device is also possible.

The previous description of specific exemplary embodiments of this invention has been presented for the purpose of illustration and description. It is not intended to be exhaustive or to limit the invention to the exact forms disclosed, and it is to be understood that various modifications and variations are possible in the light of the teaching disclosed above. The exemplary embodiments have been chosen and described to explain certain principles of the invention and their practical application, to hereby enable those skilled in the art to manufacture and use various exemplary embodiments of this invention as well as various alternatives and modifications thereof. It is intended that the scope of protection of the invention shall be defined by the attached claims and their equivalents.

1. A 3D printer (10) having a coating device (30) and a coating device cleaning device (50),
wherein the coating device (30) comprises a container (32) which defines an inner cavity (34) for receiving particulate construction material, and an output region (36) for outputting the particulate construction material, and is movable into a cleaning position in which it is arranged above the coating device cleaning device (50),
wherein the coating device cleaning device (50) comprises a wiping member (52) for wiping the output region (36),
characterized in that
the wiping member (52) is made from an absorbent material which is configured to absorb a liquid cleaning agent in itself.

2. The 3D printer (10) according to claim 1, wherein the wiping member (52) is made from an absorbent, porous sponge or an absorbent textile material.

3. The 3D printer (10) according to claim 1, wherein the wiping member (52) is movable from a cleaning device cleaning position in which the wiping member (52) is aligned for wiping the output region (36) into a wiping member cleaning position in which the wiping member (52) is aligned for a cleaning of the wiping member (52) itself, and back into the cleaning device cleaning position.

4. The 3D printer (10) according to claim 3, wherein the coating device cleaning device (50) comprises a cleaning station (70) which is configured to clean the wiping member (52) and infiltrate it with liquid cleaning agent; when the wiping member (52) is positioned in its wiping member cleaning position.

5. The 3D printer (10) according to claim 4, wherein the cleaning station (70) comprises a cleaning bath (72) of the liquid cleaning agent.

6. The 3D printer (10) according to claim 5, wherein the cleaning station (70) comprises a wiping member cleaning and cleaning agent transmission device (74) which is configured to transport cleaning agent from the cleaning bath (72) to the wiping member (52) and to clean the wiping member (52) when the wiping member (52) is located in its wiping member cleaning position, wherein the wiping member cleaning and cleaning agent transmission device (74) comprises a rotatable roller (76) having an absorbent material, which is configured to absorb liquid cleaning agent in itself.

7. The 3D printer (10) according to claim 6, wherein the cleaning station (70) comprises a cleaning agent amount adjusting device (78) which is configured to adjust the cleaning agent amount which is transported by the wiping member cleaning and cleaning agent transmission device (74) from the cleaning bath (72) to the wiping member (52).

8. The 3D printer (10) according to claim 3, wherein the wiping member (52) is further movable into a wiping member conditioning position which is located between the coating device cleaning position and the wiping member cleaning position, and in which a cleaning agent amount which is received in the wiping member (52) is adjustable.

9. The 3D printer (10) according to claim 8, wherein the coating device cleaning device (50) comprises a conditioning station (90) which is configured to adjust the cleaning agent amount which is received in the wiping member (52) when the wiping member (52) is in its wiping member conditioning position.

10. The 3D printer (10) according to claim 9, wherein the conditioning station (90) comprises a stripping and/or squeezing device (92) where the wiping member (52) can be stripped off and/or cleaning agent can be squeezed out of the wiping member (52); to discharge a part of the cleaning agent which is received in the wiping member (52) from the wiping member (52), wherein the stripping and/or squeezing device (92) is arranged above the cleaning bath (72) or is otherwise in fluid connection with the same so that the cleaning agent stripped off and/or squeezed out of the wiping member (52) can be returned to the cleaning bath (72), and/or comprises a roller (94) by which the wiping member (52) can be squeezed.

11. The 3D printer (10) according to claim 9, wherein the conditioning station (90) comprises a fluid stream supply device (96) which is configured to direct a fluid stream onto the wiping member (52) to discharge, by means of the fluid stream, a part of the cleaning agent received in the wiping member (52) from the wiping member (52), wherein the fluid stream supply device (96) is further configured to set a temperature of the fluid stream.

12. The 3D printer (10) according to claim 1, further comprising a sensor device (110) by which an amount of cleaning agent received in the wiping member (52) can be determined, wherein the sensor device (110) comprises one or more capacitive sensors (112) and/or one or more electrolytic sensors (112) and/or one or more resistive sensors (112), wherein the sensor device (110) is configured to determine the amount of cleaning agent received in the wiping member (52) when the wiping member (52) is located in one or more or each of the positions selected from the wiping member conditioning position, the coating device cleaning position and the wiping member cleaning position.

13. The 3D printer (10) according to claim 12, further comprising a control (C) which is connected to the sensor device (110) and configured to prompt, on the basis of a value received from the sensor device (110), which is representative of the amount of cleaning agent received in the wiping member (52), an adjustment of a residual amount of cleaning agent in the wiping member (52) by means of driving/controlling the conditioning station (90), wherein the control (C) sets a residual amount of cleaning agent in the wiping member (52) depending on a used construction material and/or binder system and/or cleaning agent and/or a type of the absorbent material and/or a cleaning interval of the coating device and/or a degree of contamination of the coating device.

14. The 3D printer (10) according to claim 1, wherein the coating device cleaning device (50) further comprises a driving device (54) for moving the wiping member (52), which is configured to move the wiping member (52) relative to the output region (36) for a cleaning thereof when the coating device (30) is positioned above the coating device cleaning device (50), and/or to move the wiping member (52) between the coating device cleaning position, the wiping member cleaning position and the wiping member conditioning position.

15. The 3D printer (10) according to claim 14, wherein the driving device (54) comprises a carrier structure (56) to which the wiping member (52) is releasably attached.

16. The 3D printer (10) according to claim 14, wherein the driving device (54) is configured to move the wiping member (52) into a lowered position in which a collision with the coating device (30) is avoided, wherein the wiping member (52) is located in the lowered position in the wiping member cleaning position and/or in the wiping member conditioning position, whereas it is arranged in an elevated position in the coating device cleaning position.

17. The 3D printer (10) according to claim 14, wherein the driving device (54) is configured to move the wiping member (52) for a cleaning of the output region (36) along the same when the coating device (30) is positioned above the coating device cleaning device (50), wherein the driving device (54) is configured to move the wiping member (52) along a circulating path which extends with a first path section along the output region (36) when the coating device (30) is in the coating device cleaning position, wherein the driving device (54) comprises an elongate carrier structure (56) to which the wiping member (52) is attached and which is movable in a longitudinal direction in a way to revolve around an external point to thereby move the wiping member (52) along its circulating path.

18. The 3D printer (10) according to claim 1, wherein the output region (36) comprises an elongate output slot (40) and/or at least one elongate stroking surface which is configured to stroke construction material output from the container (32) to thereby level and/or compress the output construction material, wherein the at least one elongate stroking surface can be wiped off by the wiping member (52) and/or, wherein, the wiping member (52) has an extension in a width direction extending crosswise to the longitudinal direction of the elongate stroking surface; which is greater than or equal to that of the elongate stroking surface.

19. The 3D printer (10) according to claim 1, wherein the coating device cleaning device (50) comprises a plurality of wiping members (52) which are movable together into a respectively lowered position to avoid a collision with the coating device (30).

20. The 3D printer (10) according to claim 1, further comprising a first sensor (170) which is configured to detect a position of the wiping member (52), and/or a second sensor (82) which is configured to detect a filling level of the cleaning bath (72).

21. The 3D printer (10) according to claim 1, further comprising a printing device having a print head for selectively solidifying a partial area of a construction material layer applied by means of the coating device and/or for selectively printing a treatment agent onto a construction material layer applied by means of the coating device.

22. A method for cleaning a coating device (30) of a 3D printer (10), the coating device (30) comprising a container (32) which defines an inner cavity (34) for receiving particulate construction material and has an output region (36) for outputting the particulate construction material, the method comprising:
moving the coating device (30) into a cleaning position in which the coating device (30) is arranged above a coating device cleaning device (50) comprising a wiping member (52) which is made from an absorbent material configured to absorb a liquid cleaning agent in itself, and
wiping the output region (36) by the wiping member (52) in a state in which the wiping member (52) is moistened with a liquid cleaning agent.

23. The method for cleaning a coating device (30) of a 3D printer (10) according to claim 22, further comprising:
moving the wiping member (52) to a cleaning station (70) and cleaning the wiping member (52) and/or infiltrating the wiping member (52) with cleaning agent in the cleaning station (70), and/or
moving the wiping member (52) to a conditioning station (90) and adjusting a cleaning agent amount received in the wiping member (52), in the conditioning station (90), and/or
determining an amount of cleaning agent received in the wiping member (52) using a sensor (112), and/or
moving the wiping member (52) into a lowered position to avoid a collision with the coating device (30), after wiping the output region (36) using the wiping member (52), and/or
replacing the wiping member (52) with another wiping member (52) once the wiping member (52) is worn out or is adapted to use a construction material and/or binder system and/or cleaning agent.

24. The method for cleaning a coating device (30) of a 3D printer (10) according to claim 22, wherein
the output region (36) has an elongate shape and wiping the output region (36) using the wiping member (52) is substantially carried out in a longitudinal direction of the output region (36), and/or
moving the wiping member (52) takes place on a closed trajectory, and/or
the method for cleaning the coating device (30) takes place in a software-controlled way.
